(19) United States
(12) Patent Application Publication
(10) Pub. No.: US 2007/0009245 A1
(43) Pub. Date: Jan. 11, 2007

(54) Imaging apparatus and imaging method

(75) Inventor: Takehiko Ito, Saitama-ken (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/480,446

(22) Filed: Jul. 5, 2006

(30) Foreign Application Priority Data
Jul. 8, 2005 (JP) 2005-200457

(51) Int. Cl. G03B 17/00

(52) U.S. Cl. 396/55

(57) ABSTRACT

An imaging apparatus includes the functions of conducting automatic exposure control and of conducting shake correction with respect to digital image data acquired by an image pickup unit. The imaging apparatus includes: a determining unit that determines whether or not the shake correction is being implemented; and a switching unit which, when it has been determined by the determining unit that the shake correction is being implemented, switches the shutter speed such that the shutter speed is raised in comparison to when it has been determined by the determining unit that the shake correction is not being implemented. An imaging method determines whether or not the shake correction is being implemented, and when it has been determined that the shake correction is being implemented, switches the shutter speed such that the shutter speed is raised in comparison to when it has been determined that the shake correction is not being implemented.

### CROSS-REFERENCE TO RELATED APPLICATION

This application claims priority under 35 USC 119 from Japanese Patent Application No. 2005-200457, the disclosure of which is incorporated by reference herein.

### BACKGROUND OF THE INVENTION

1. Field of the Invention

The present invention relates to an imaging apparatus and an imaging method, and in particular to an imaging apparatus and an imaging method that include the function of conducting automatic exposure control and the function of conducting shake correction with respect to digital image data acquired by an image pickup unit.

2. Description of the Related Art

Conventionally, there has been technology that electronically conducts shake correction when a moving image is picked up. As this type of technology, Japanese Patent Application Publication (JP-A) No. 11-98420 proposes an electronic shake correction apparatus configured to prevent the deterioration of correction performance resulting from changes in the shutter speed.

However, even when the apparatus proposed in JP-A No. 11-98420 is used, shake or subject-shake within one frame occurs when the shutter speed is low at the time of shake correction when conducting moving image imaging. For this reason, when the shutter speed is low, a sharp image cannot be obtained in one frame and oftentimes a moving image after shake correction becomes not sharp. Moreover, assuming that this shake correction is conducted in view of the correlation between frames on the basis of moving vectors, the appropriate correlation between frames becomes incalculable due to shake occurring within one frame. Thus, the problem that the precision of the shake correction deteriorates can also occur.

In view of these circumstances, the present invention provides an imaging apparatus and an imaging method where image quality deterioration resulting from shake is suppressed and with which a sharp image can be obtained.

### SUMMARY OF THE INVENTION

A first aspect of the invention provides an imaging apparatus including the function of conducting automatic exposure control and the function of conducting shake correction with respect to digital image data acquired by an image pickup unit, the imaging apparatus comprising: a determining unit that determines whether or not the shake correction is being implemented; and a switching unit which, when it has been determined by the determining unit that the shake correction is being implemented, switches the shutter speed such that the shutter speed is raised in comparison to when it has been determined by the determining unit that the shake correction is not being implemented.

A second aspect of the invention provides an imaging apparatus including the function of conducting automatic exposure control and the function of conducting shake correction with respect to digital image data acquired by an image pickup unit, the imaging apparatus comprising: a determining unit that determines whether or not the shake correction is being implemented; a switching unit which, when it has been determined by the determining unit that the shake correction is being implemented, switches the shutter speed such that the shutter speed is raised in comparison to when it has been determined by the determining unit that the shake correction is not being implemented; an adjusting unit that adjusts the sensitivity of the image pickup unit; a changing unit which, when it has been determined by the determining unit that the shake correction is being implemented, changes the sensitivity of the image pickup unit such that the sensitivity is raised in comparison to when it has been determined by the determining unit that the shake correction is not being implemented; a shutter speed detecting unit that detects the shutter speed; a limiting unit that limits the shutter speed such that the shutter speed detected by the shutter speed detecting unit becomes equal to or greater than a predetermined speed when it has been determined by the determining unit that the shake correction is being implemented; and a warning unit that issues a warning when a shutter speed less than the predetermined speed has been detected by the shutter speed detecting unit.

A third aspect of the invention provides an imaging method including the function of conducting automatic exposure control and the function of conducting shake correction with respect to digital image data acquired by an image pickup unit, the imaging method comprising: determining whether or not the shake correction is being implemented; and when it has been determined that the shake correction is being implemented, switching the shutter speed such that the shutter speed is raised in comparison to when it has been determined that the shake correction is not being implemented.

Other aspects, features and advantages of the present invention will become apparent from the following description taken in conjunction with the accompanying drawings.

### BRIEF DESCRIPTION OF THE DRAWINGS

Preferred embodiments of the present invention will be described in detail based on the following figures, in which:

FIG. 1 is a diagram showing the exterior of a digital camera according to an embodiment of the invention;

FIG. 2 is a block diagram showing the configuration of relevant portions of an electrical system of a digital camera according to a first embodiment of the invention;

FIG. 3A is a program diagram when a shake correction mode is unset;

FIG. 3B is a program diagram where shutter speed is maintained at a speed equal to or greater than a shake limit shutter speed;

FIG. 3C is a program diagram when ISO sensitivity is raised;

FIG. 4 is a flow chart showing the flow of processing in the digital camera according to the first embodiment of the invention;

FIG. 5 is a flow chart showing the flow of processing in a digital camera according to a second embodiment of the invention;

FIG. 6 is a block diagram showing the configuration of relevant portions of an electrical system of a digital camera according to a third embodiment of the invention;

FIG. 7 is a flow chart showing the flow of processing in the digital camera according to the third embodiment of the invention;

FIG. 8 is a flow chart showing the flow of processing in a digital camera according to a fourth embodiment of the invention; and

FIG. 9 is a diagram showing an LCD when a warning is displayed in the fourth embodiment.

### DETAILED DESCRIPTION OF THE INVENTION

Embodiments of the present invention will be described in detail below with reference to the drawings. Here, a case will be described where the invention is applied to a digital camera 10 that includes the functions of imaging both still images and moving images.

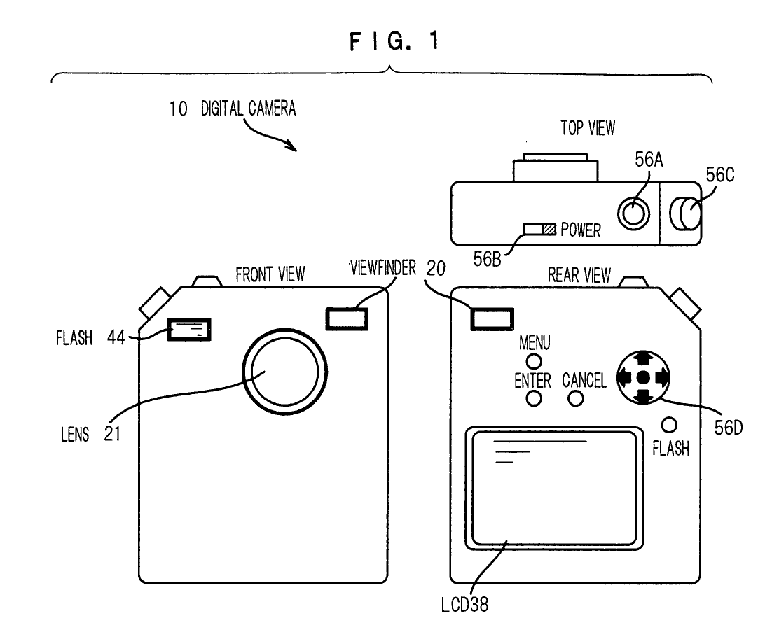

First, the external configuration of the digital camera 10 according to an embodiment of the invention will be described with reference to FIG. 1.

The digital camera 10 includes a front surface disposed with a lens 21 for imaging a subject image, a flash 44 that emits light (image fill-in light) onto a subject as needed at the time of imaging, and a viewfinder 20 that is used in order to determine the composition of the subject to be imaged. Further, the digital camera 10 is provided in its top surface with a release button (shutter) 56A that is depressed when executing imaging, a power switch 56B, and a mode switch 56C.

The release button 56A of the digital camera 10 according to the present embodiment is configured such that two stages of depression are detectable. The first is when the release button 56A is depressed to an intermediate position (“half-depressed”), and the second is when the release button 56A is depressed to a final depressed position beyond the intermediate position (“fully depressed”).

In the digital camera 10, when the release button 56A is half-depressed, an automatic exposure (AE) function is activated and exposure conditions (shutter speed, aperture value) are set. Then, an auto focus (AF) function is activated and focus is adjusted. Then, when the release button 56A is fully depressed, exposure (imaging) is conducted.

The mode switch 56C is rotated when setting the mode to any of a still image imaging mode where imaging of a still image is conducted, a moving-image imaging mode where imaging of a moving image is conducted, a shake correction mode where shake correction is conducted, and a playback mode where a subject image is played back on a later-described liquid crystal display (hereinafter referred to as LCD) 38. The mode switch 56C is also configured such that it can be set to a shutter speed priority mode when it is rotated and set to the shake correction mode.

The digital camera 10 is also provided in its rear surface with an eyepiece portion of the viewfinder 20, the LCD 38 for displaying imaged subject images and menu screens, and an arrow cursor button 56D. The arrow cursor button 56D is configured to include four arrow buttons representing the four moving directions of up, down, right, and left in the display region of the LCD 38.

On the back surface of the digital camera 10 are also provided a menu button that is depressed when displaying a menu screen on the LCD 38, an enter button that is depressed when entering the operation content up to that point in time, a cancel button that is depressed when canceling the prior operation content, and a flash button that is depressed when setting the flash conditions of the flash 44.

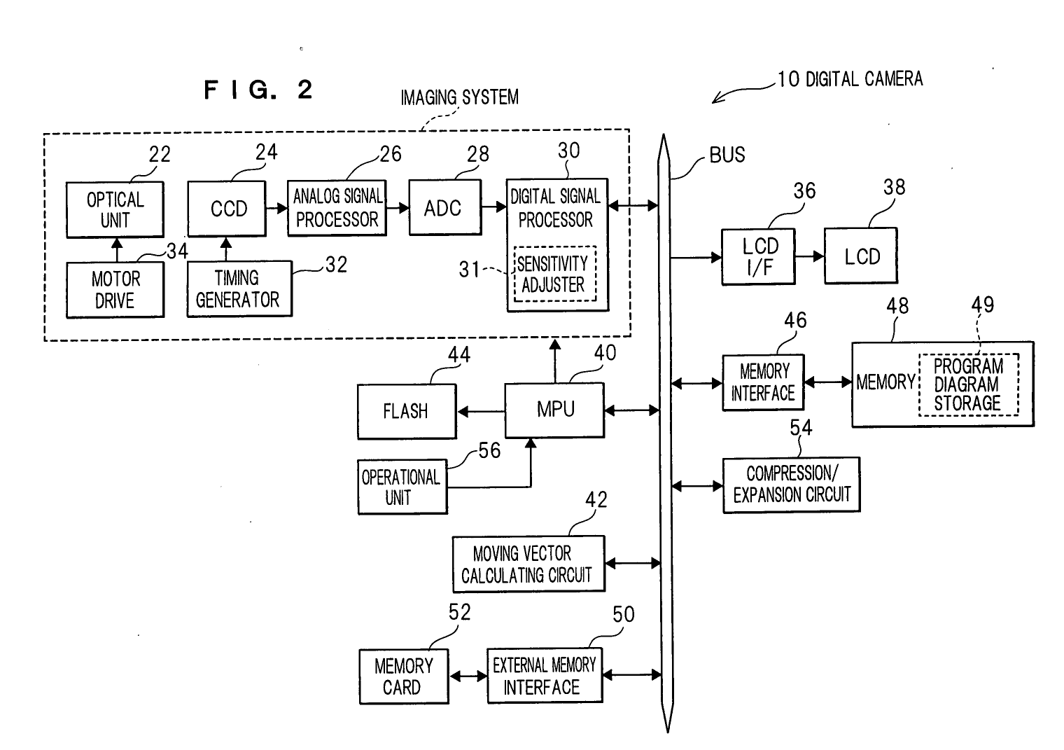

Next, the configuration of the relevant portions of the electrical system of the digital camera 10 according to the present embodiment will be described with reference to FIG. 2.

The digital camera 10 is configured to include an optical unit 22 that includes the lens 21, a charge coupled device (CCD) 24 disposed at the rear side of the optical axis of the lens 21, and an analog signal processor 26 that conducts various kinds of analog signal processing with respect to inputted analog signals.

The digital camera 10 is also configured to include an analog/digital converter (ADC) 28, which converts inputted analog signals to digital data, and a digital signal processor 30, which conducts various kinds of digital signal processing with respect to inputted digital data.

The digital signal processor 30 internally houses a line buffer with a predetermined capacity and conducts control that causes inputted digital data to be directly stored in a predetermined region of a later-described memory 48.

The output end of the CCD 24 is connected to the input end of the analog signal processor 26, the output end of the analog signal processor 26 is connected to the input end of the ADC 28, and the output end of the ADC 28 is connected to the input end of the digital signal processor 30. Consequently, predetermined analog signal processing is undertaken by the analog signal processor 26 to an analog signal representing a subject image outputted from the CCD 24, the analog signal is converted by the ADC 28 into digital image data (data of the colors of red (R), green (G) and blue (B), as will be described later), and the digital image data is inputted to the digital signal processor 30.

The digital signal processor 30 according to the present embodiment includes amplifiers (not shown), which correspond to the respective colors of red, green and blue, and a sensitivity adjuster 31, which conducts sensitivity adjustment by setting the values of the digital gains corresponding to the ISO sensitivities set with respect to the amplifiers.

The sensitivity adjuster 31 may also be disposed in the analog signal processor 26.

The digital camera 10 is also configured to include: an LCD interface 36 that generates, and supplies to the LCD 38, a signal for causing subject images and menu screens to be displayed on the LCD 38; a microprocessing unit (MPU) 40 that controls the operation of the entire digital camera 10; a moving vector calculating circuit 42 that calculates moving vectors; the memory 38 that stores digital image data obtained by imaging; and a memory interface 46 that controls access with respect to the memory 48.

The shake correction in the shake correction mode of the present embodiment is conducted by deriving the correlation between frames based on the moving vector that the moving vector calculating circuit 42 has calculated, but the moving vector calculating circuit 42 may also be substituted with a gyro sensor that detects the direction in which the digital camera 10 moves, and the amount that the digital camera 10 moves, from a predetermined position.

The memory 48 is configured to include a program diagram storage 49 that stores plural program diagrams per ISO sensitivity. The program diagrams represent the manner of switching between the shutter speed and the aperture value. That is, the program diagrams control the AE function and are uniquely programmed for each digital camera characteristic.

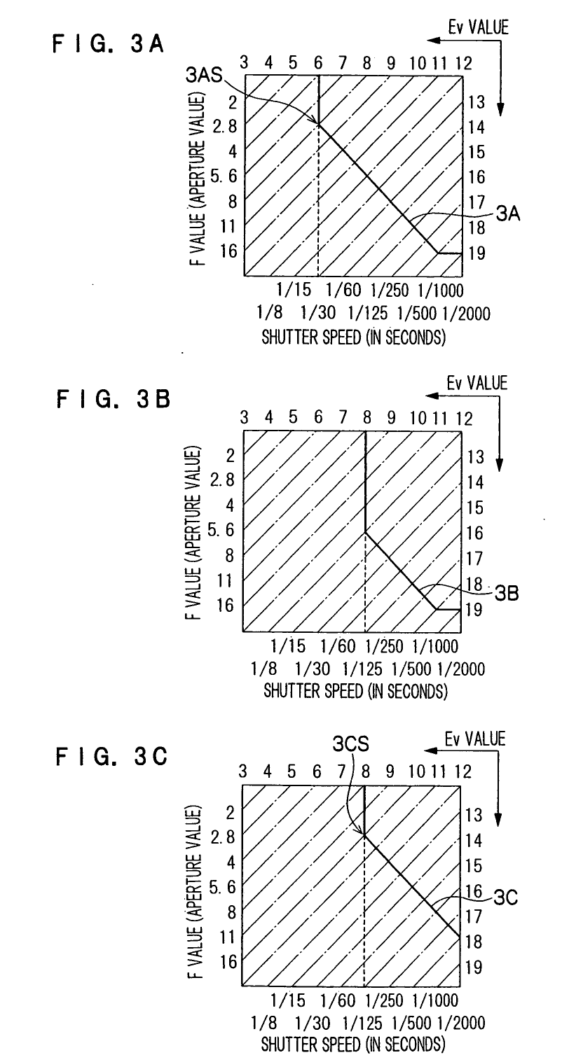

FIGS. 3A to 3C show examples of the program diagrams. FIG. 3A shows a first program diagram 3A, FIG. 3B shows a second program diagram 3B, and FIG. 3C shows a third program diagram 3C. In each of these program diagrams, the horizontal axis represents the shutter speed, the vertical axis represents the aperture value, and the slanted axis represented by one-dot chain lines represents the Ev value (exposure value). Ev is a photometric unit, and the Ev value represents subject brightness.

The shutter speed has a threshold where the potential for shake to occur increases. This is called the shake limit shutter speed. The shake limit shutter speed is the inverse of the focal distance of the lens, and is determined dependently on the lens. For example, in the first program diagram 3A shown in FIG. 3A, the shutter speed indicated by arrow 3AS is the shake limit shutter speed.

The first program diagram 3A in FIG. 3A is a program diagram that is used when the shake correction mode is unset when the ISO sensitivity has been set to ISO 200. The shake limit shutter speed in this program diagram is determined by the focal distance of the lens during ordinary imaging.

The second program diagram 3B in FIG. 3B is a program diagram that is used when the shake correction mode has been set when the ISO sensitivity has been set to ISO 200.

The third program diagram 3C in FIG. 3C is a program diagram when the ISO sensitivity has been set to ISO 800.

The digital camera 10 is also configured to include an external memory interface 50 for enabling a portable memory card 52 to be accessed by the digital camera 10 and a compression/expansion circuit 54 that compresses and expands digital image data.

In the digital camera 10 of the present embodiment, a Flash Memory is used as the memory 48, and Smart Media® is used as the memory card 52.

The digital signal processor 30, the LCD interface 36, the MPU 40, the memory interface 46, the external memory interface 50 and the compression/expansion circuit 54 are interconnected via a system bus. Consequently, the MPU 40 can control the operation of the digital signal processor 30 and the compression/expansion circuit 54, can cause various types of information to be displayed on the LCD 38 via the LCD interface 36, and can access the memory 48 and the memory card 52 via the memory interface 46 and the external memory interface 50. The MPU 40 also switches between the program diagrams stored in the program diagram storage 49.

A timing generator 32 that generates, and supplies to the CCD 24, a timing signal for driving mainly the CCD 24 is disposed in the digital camera 10, and the driving of the CCD 24 is controlled by the MPU 40 via the timing generator 32.

A motor drive 34 is disposed in the digital camera 10, and the driving of a focusing motor, a zoom motor and an aperture drive motor disposed in the optical unit 22 is also controlled by the MPU 40 via the motor drive 34.

That is, the lens 21 according to the present embodiment includes plural lenses, is configured as a zoom lens whose focal distance can be changed (varied), and is disposed with an unillustrated lens drive mechanism. The focusing motor, the zoom motor and the aperture drive motor are included in this lens drive mechanism, and these motors are driven by drive signals supplied by the control of the MPU 40 from the motor drive 34.

Various types of buttons and switches (called “operational unit 56” in FIG. 2), such as the release button 56A, the power switch 56B, the mode switch 56C, the arrow cursor button 56D and the menu button, are connected to the MPU 40, and the MPU 40 always grasps the status of operation with respect to the operation unit 56. The flash 44 is also connected to the MPU 40, and the emission of the imaging fill light by the flash 44 is also controlled by the MPU 40.

Next, the action of the first embodiment will be described.

First, the CCD 24 conducts imaging via the optical unit 22 and sequentially outputs to the analog signal processor 26 analog signals of red, green and blue representing the subject image. The analog signal processor 26 administers analog signal processing such as correlated double sampling with respect to the analog signals inputted from the CCD 24, and then sequentially outputs the processed analog signals to the ADC 28.

The ADC 28 converts the analog signals of red, green and blue inputted from the analog signal processor 26 to 12-bit signals of red, green and blue (digital image data), and then sequentially outputs the digital image data to the digital signal processor 30. The digital signal processor 30 accumulates in its line buffer the digital image data sequentially inputted from the ADC 28, and directly stores the digital image data in a predetermined region of the memory 48.

The digital image data stored in the predetermined region of the memory 48 is read by the digital signal processor 30 in response to the control by the MPU 40, white balance adjustment is conducted by applying a digital gain corresponding to a predetermined physical quantity, and gamma processing, sharpness processing and sensitivity adjustment are conducted to generate 8-bit digital image data.

Then, the digital signal processor 30 undertakes YC signal processing on the generated 8-bit digital image data, generates a luminance signal Y and chroma signals Cr and Cb (called a “YC signal” below), and stores the YC signal in a region of the memory 48 different from the aforementioned predetermined region.

The LCD 38 is configured such that it can also be used as a viewfinder to display a moving image (through-image) obtained by continuous imaging with the CCD 24. When the LCD 38 is used as a viewfinder, the generated YC signals are sequentially outputted to the LCD 38 via the LCD interface 36. Thus, the through-image is displayed on the LCD 38.

Here, when the still image imaging mode has been set, the AE function is activated and the exposure conditions are set as described above at the timing when the release button 56A is half-depressed by the user. Then, the AF function is activated so that the focus is adjusted. Then, image fill-in light is emitted from the flash 44 as needed at the timing when the release button 56A is fully depressed. The YC signal stored in the memory 48 is compressed at that point in time in a predetermined compression format (in the present embodiment, the JPEG format) by the compression/expansion circuit 54 and is recorded as a digitized file in the memory card 52 via the external memory interface 50.

When the moving-image imaging mode has been set, the image fill-in light is emitted from the flash 44 as needed at the timing when the release button 56A is fully depressed. Then, the YC signal stored in the memory 48 is compressed in a predetermined compression format (in the present embodiment, the Motion JPEG format) by the compression/expansion circuit 54 and is recorded in the memory card 52 via the external memory interface 50. The recording operation ends at the timing when the release button 56A is again fully depressed. The moving-image data representing the moving image is recorded in the memory card 52 as a digitized file by this operation.

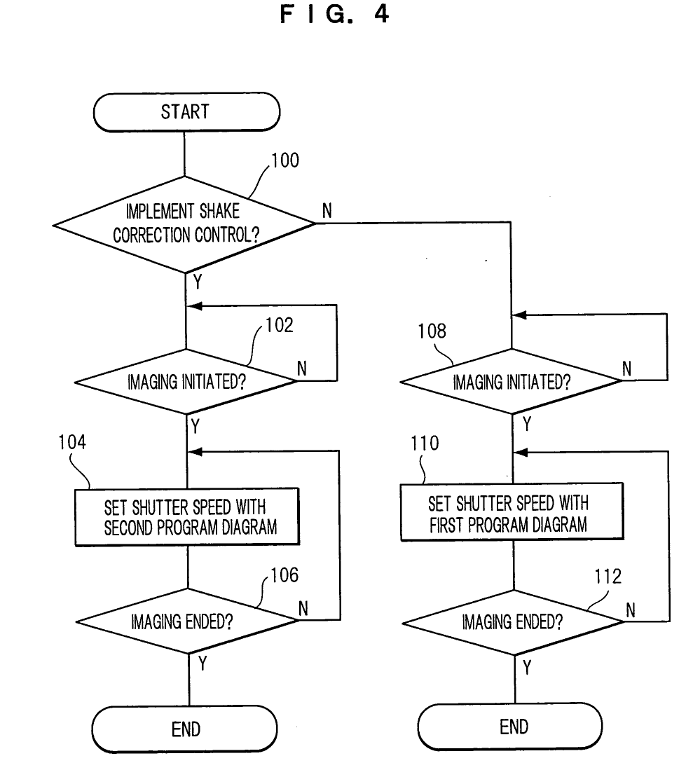

Incidentally, the digital camera 10 of the first embodiment is disposed with the function of switching between the program diagrams by setting the shake correction mode. The action of the portion relating to this function will be described in detail in accordance with the flow chart of FIG. 4.

First, it is determined in step 100 by the determination of the MPU 40 whether or not the mode switch 56C has been rotated and set to the shake correction mode. When the mode switch 56C has been set to the shake correction mode and the determination in step 100 is YES, then the processing moves to step 102, and when the determination in step 100 is NO, then the processing moves to step 108.

In step 102, it is determined whether or not imaging has been initiated. When imaging has been initiated and the determination in step 102 is YES, then the processing moves to step 104, and when the determination in step 102 is NO, then step 102 is repeated and the same determination is again conducted.

In step 104, the program diagram is switched to the second program diagram 3B, and the shutter speed is switched and the aperture value is changed on the basis of the second program diagram 3B.

Next, it is determined in step 106 whether or not imaging has ended. When imaging has ended and the determination in step 106 is YES, then the processing of the flow chart ends, and when the determination in step 106 is NO, then the processing moves to step 104.

When the determination in step 100 is NO and the processing moves to step 108, it is determined whether or not imaging has been initiated. When imaging has been initiated and the determination in step 108 is YES, then the processing moves to step 110, and when the determination in step 108 is NO, then step 108 is repeated and the same determination is again conducted.

In step 110, the program diagram is switched to the first program diagram 3A, and the shutter speed is switched and the aperture value is changed on the basis of the first program diagram 3A.

Next, it is determined in step 112 whether or not imaging has ended. When imaging has ended and the determination in step 112 is YES, then the processing ends, and when the determination in step 112 is NO, then the processing moves to step 110.

In this manner, in the first embodiment, when the shake correction mode has been set, the shutter speed is increased, shake within one frame can be prevented, image quality deterioration resulting from shake is suppressed, and a sharp image can be obtained.

Next, a digital camera 10 according to a second embodiment of the invention will be described.

Reference numerals that are the same as those in the first embodiment will be given to portions having basically the same configuration as those in the first embodiment, and description of those portions will be omitted.

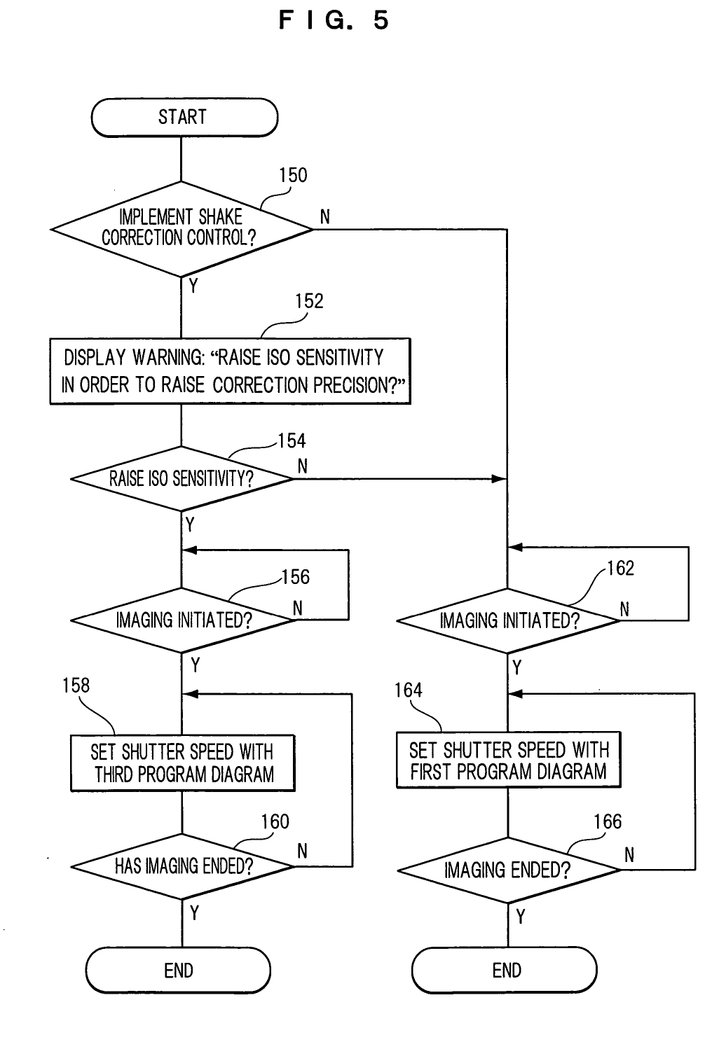

The digital camera 10 of the second embodiment is equipped with the function of increasing the shutter speed by raising the ISO sensitivity when the shake correction mode has been set. The action of the portion relating to this function will be described in detail in accordance with the flow chart of FIG. 5.

First, it is determined in step 150 by the determination of the MPU 40 whether or not the mode switch 56C has been rotated and set to the shake correction mode. When the mode switch 56C has been set to the shake correction mode and the determination in step 150 is YES, then the processing moves to step 152, and when the determination in step 150 is NO, then the processing moves to step 162.

In step 152, a warning is displayed on the LCD 38 questioning the user whether the user wants to raise the ISO sensitivity in order to raise the correction precision.

Next, it is determined in step 154 whether or not the ISO sensitivity is to be raised as a result of the user being prompted by the warning in step 152. When the ISO sensitivity is to be raised and the determination in step 154 is YES, then the processing moves to step 156, and when the determination in step 154 is NO, then the processing moves to step 162.

In step 156, it is determined whether or not imaging has been initiated. When imaging has been initiated and the determination in step 156 is YES, then the processing moves to step 158, and when the determination in step 156 is NO, then step 156 is repeated and the same determination is again conducted.

In step 158, the program diagram is switched to the third program diagram 3C, and the shutter speed is switched and the aperture value is changed on the basis of the third program diagram 3C.

That is, the sensitivity is adjusted by the sensitivity adjuster 31, and the ISO sensitivity is raised from ISO 200 to ISO 800. Then, the shutter speed that had been 1/30, before the processing of step 158 is conducted, as indicated by arrow 3AS in FIG. 3A is increased to the shutter speed of 1/125 indicated by arrow 3CS in FIG. 3C as a result of the ISO sensitivity being raised in step 158. Meanwhile, the aperture value remains unchanged at 2.8 in step 158.

Next, it is determined in step 160 whether or not imaging has ended. When imaging has ended and the determination in step 160 is YES, then the processing of the flow chart ends, and when the determination in step 160 is NO, then the processing moves to step 158.

When the determinations in step 150 and step 154 are NO and the processing moves to step 162, it is determined whether or not imaging has been initiated. When imaging has been initiated and the determination in step 162 is YES, then the processing moves to step 164, and when the determination in step 162 is NO, then step 162 is repeated and the same determination is again conducted.

In step 164, the program diagram is switched to the first program diagram 3A, and the shutter speed is switched and the aperture value is changed on the basis of the first program diagram 3A.

Next, it is determined in step 166 whether or not imaging has ended. When imaging has ended and the determination in step 166 is YES, then the processing of the flow chart ends, and when the determination in step 166 is NO, then the processing moves to step 164.

In this manner, in the second embodiment, the shutter speed can be increased by raising the ISO sensitivity. Thus, shake within one frame can be prevented, image quality deterioration resulting from shake is suppressed, and a sharp image can be obtained.

Next, a digital camera 10 according to a third embodiment of the invention will be described.

Reference numerals that are the same as those in the first embodiment will be given to portions having basically the same configuration as those in the first embodiment, and description of those portions will be omitted.

The third embodiment is one where the mode is set to a shutter speed priority mode during the shake correction mode.

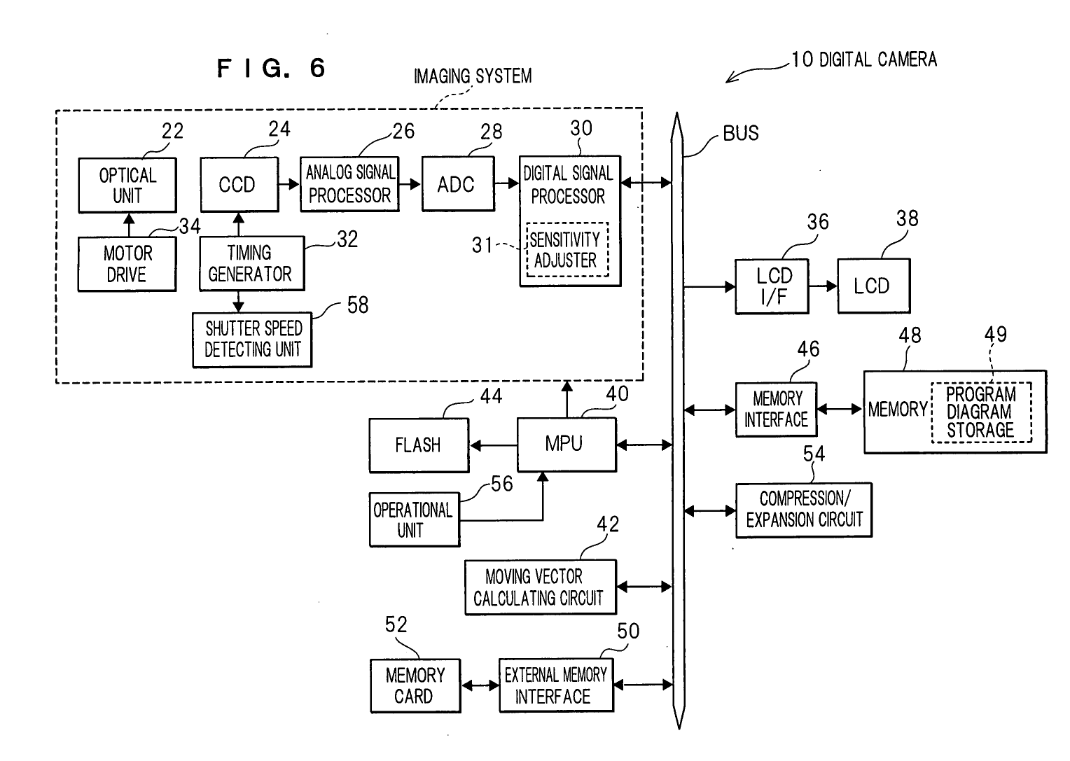

As shown in FIG. 6, the digital camera 10 is disposed with a shutter speed detecting unit 58 that measures the shutter speed. The shutter speed detecting unit 58 is configured to receive from the timing generator 32 a timing signal for driving the CCD 24 and to measure the shutter speed on the basis of the exposure time of the CCD 24.

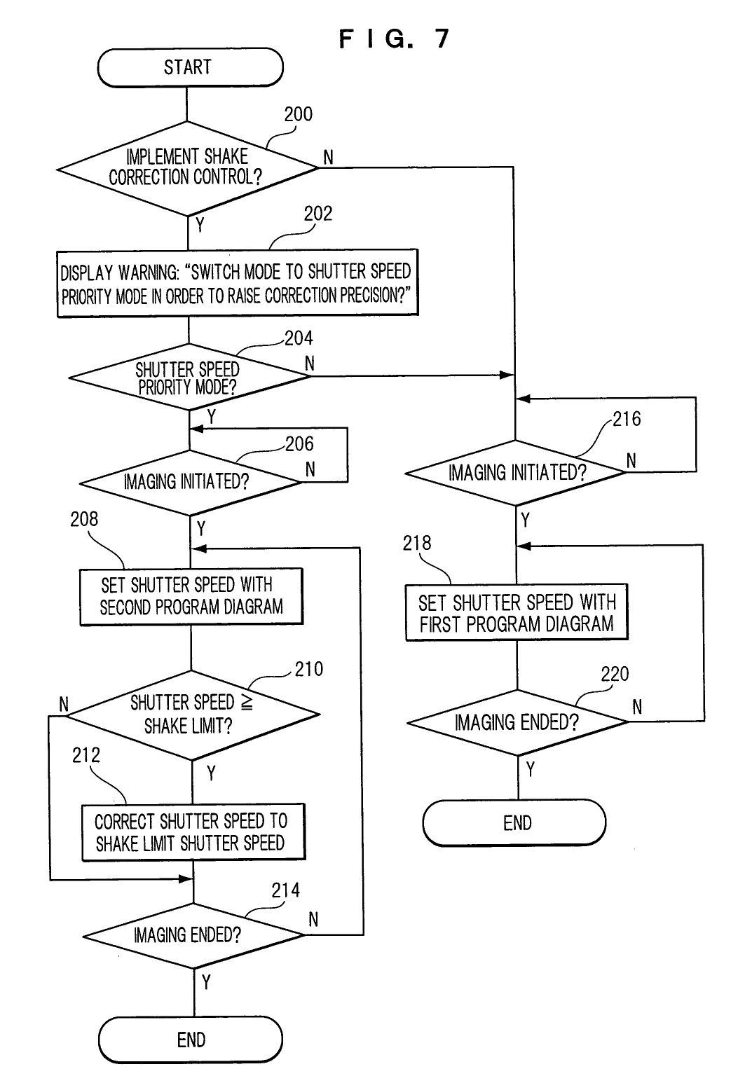

In the third embodiment, the digital camera 10 includes a function where the shutter speed is maintained at a speed equal to or greater than the shake limit shutter speed as a result of the shutter speed detecting unit 58 measuring the shutter speed, and where the shutter speed detecting unit 58 outputs a signal when the shutter speed becomes less than the shake limit shutter speed. The action of the portion relating to this function will be described in detail in accordance with the flow chart of FIG. 7.

First, it is determined in step 200 by the determination of the MPU 40 whether or not the mode switch 56C has been rotated and set to the shake correction mode. When the mode switch 56C has been set to the shake correction mode and the determination in step 200 is YES, then the processing moves to step 202, and when the determination in step 200 is NO, then the processing moves to step 216.

In step 202, a warning is displayed on the LCD 38 questioning the user whether the user wants to switch the mode to the shutter speed priority mode in order to raise the correction precision.

Next, it is determined in step 204 whether or not the mode is to be switched to the shutter speed priority mode as a result of the user being prompted by the warning in step 202. When the mode is to be switched to the shutter speed priority mode and the determination in step 204 is YES, then the processing moves to step 206, and when the determination in step 204 is NO, then the processing moves to step 216.

In step 206, it is determined whether or not imaging has been initiated. When imaging has been initiated and the determination in step 206 is YES, then the processing moves to step 208, and when the determination in step 206 is NO, then step 206 is repeated and the same determination is again conducted.

In step 208, the program diagram is switched to the second program diagram 3B, and the shutter speed is switched and the aperture value is changed on the basis of the second program diagram 3B.

In step 208, the third program diagram 3C may be used rather than the second program diagram 3B.

Next, it is determined in step 210 whether or not the shutter speed measured by the shutter speed detecting unit 58 is equal to or greater than the shake limit shutter speed. When the shutter speed is equal to or greater than the shake limit shutter speed and the determination in step 210 is YES, then the processing moves to step 212, and when the determination in step 210 is NO, then the processing moves to step 214.

In step 212, the shutter speed is corrected to the shake limit shutter speed.

Next, it is determined in step 214 whether or not imaging has ended. When imaging has ended and the determination in step 214 is YES, then the processing of the flow chart ends, and when the determination in step 214 is NO, then the processing moves to step 208.

When the determinations in step 200 and step 204 are NO and the processing moves to step 216, it is determined whether or not imaging has been initiated. When imaging has been initiated and the determination in step 216 is YES, then the processing moves to step 218, and when the determination in step 216 is NO, then step 216 is repeated and the same determination is again conducted.

In step 218, the program diagram is switched to the first program diagram 3A, and the shutter speed is switched and the aperture value is changed on the basis of the first program diagram 3A.

Next, it is determined in step 220 whether or not imaging has ended. When imaging has ended and the determination in step 220 is YES, then the processing of the flow chart ends, and when the determination in step 220 is NO, then the processing moves to step 218.

In this manner, in the third embodiment, the shutter speed is maintained at a speed equal to or greater than the shake limit shutter speed, whereby shake within one frame can be prevented, image quality deterioration resulting from shake is suppressed, and a sharp image can be obtained.

Next, a digital camera 10 according to a fourth embodiment will be described.

Reference numerals that are the same as those in the first embodiment will be given to portions having basically the same configuration as those in the third embodiment, and description of those portions will be omitted.

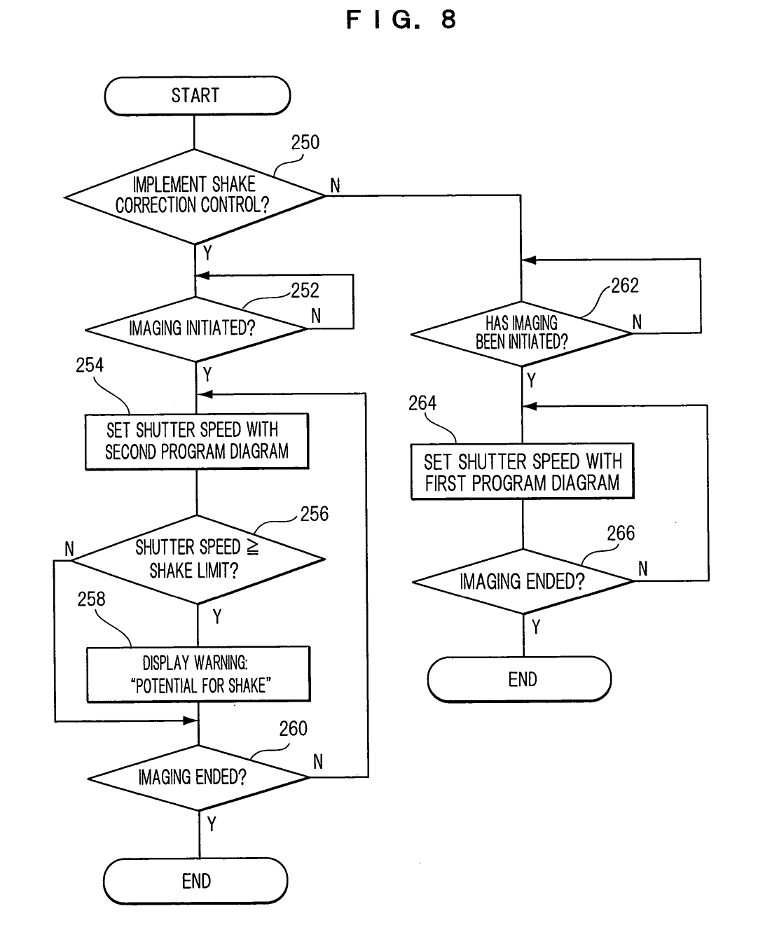

The digital camera 10 of the fourth embodiment is disposed with the function of issuing a warning that the shutter speed has become equal to or greater than the shake limit shutter speed and that there is a greater potential for shake. The action of the portion relating to this function will be described in detail in accordance with the flow chart of FIG. 8.

First, it is determined in step 250 by the determination of the MPU 40 whether or not the mode switch 56C has been rotated and set to the shake correction mode. When the mode switch 56C has been set to the shake correction mode and the determination in step 250 is YES, then the processing moves to step 252, and when the determination in step 250 is NO, then the processing moves to step 262.

In step 252, it is determined whether or not imaging has been initiated. When imaging has been initiated and the determination in step 252 is YES, then the processing moves to step 254, and when the determination in step 252 is NO, then step 252 is repeated and the same determination is again conducted.

In step 254, the program diagram is switched to the second program diagram 3B, and the shutter speed is switched and the aperture value is changed on the basis of the second program diagram 3B.

Next, it is determined in step 256 whether or not the shutter speed measured by the shutter speed detecting unit 58 is equal to or greater than the shake limit shutter speed. When the shutter speed is equal to or greater than the shake limit shutter speed and the determination in step 256 is YES, then the processing moves to step 258, and when the determination in step 256 is NO, then the processing moves to step 260.

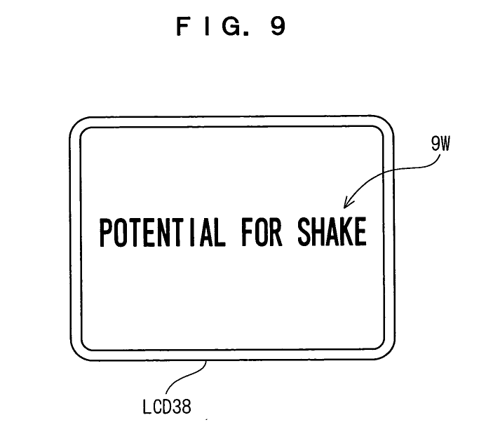

In step 258, the LCD 38 receives the signal outputted by the shutter speed detecting unit 58 via the LCD interface 36, whereby the LCD 38 displays a warning such as the one indicated by arrow 9W in FIG. 9.

Next, it is determined in step 260 whether or not imaging has ended. When imaging has ended and the determination in step 260 is YES, then the processing of the flow chart ends, and when the determination in step 260 is NO, then the processing moves to step 254.

When the determination in step 250 is NO and the processing moves to step 262, it is determined whether or not imaging has been initiated. When imaging has been initiated and the determination in step 262 is YES, then the processing moves to step 264, and when the determination in step 262 is NO, then step 262 is repeated and the same determination is again conducted.

In step 264, the program diagram is switched to the first program diagram 3A, and the shutter speed is switched and the aperture value is changed on the basis of the first program diagram 3A.

Next, it is determined in step 266 whether or not imaging has ended. When imaging has ended and the determination in step 266 is YES, then the processing of the flow chart ends, and when the determination in step 266 is NO, then the processing moves to step 264.

In this manner, in the fourth embodiment, a warning is displayed when the shutter speed has reached the shake limit shutter speed, whereby shake within one frame can be prevented, image quality deterioration resulting from shake is suppressed, and a sharp image can be obtained.

In the preceding embodiments, a case was described where the shutter speed was changed as a result of switching the program diagram, but the present invention is not limited thereto. For example, the present invention can also be configured such that the shutter speed is directly increased or increased by an arithmetic expression. In these cases also, effects that are the same as those of the preceding embodiments can be obtained.

Further, in the foregoing embodiments, a case was described where a predetermined speed of the shutter speed was used as the shake limit shutter speed, but the present invention is not limited thereto. For example, a value where a predetermined coefficient is multiplied by a predetermined value set by AE can also be the predetermined speed of the shutter speed. In this case also, effects that are the same as those of the preceding embodiments can be obtained.

Moreover, in the foregoing embodiments, a case was described where a warning was issued by display on the LCD 38, but the present invention is not limited thereto. For example, the warning can also be issued by a speaker (not shown) or by lighting a LED lamp (not shown). In these cases also, effects that are the same as those of the preceding embodiments can be obtained.

While the present invention has been illustrated and described with respect to specific embodiments thereof, it is to be understood that the present invention is by no means limited thereto and encompasses all changes and modifications which will become possible without departing from the spirit and scope of the present invention.

What is claimed is:

1. An imaging apparatus including the function of conducting automatic exposure control and the function of conducting shake correction with respect to digital image data acquired by an image pickup unit, the imaging apparatus comprising:
a determining unit that determines whether or not the shake correction is being implemented; and
a switching unit which, when it has been determined by the determining unit that the shake correction is being implemented, switches the shutter speed such that the shutter speed is raised in comparison to when it has been determined by the determining unit that the shake correction is not being implemented.

2. The imaging apparatus of claim 1, further comprising
an adjusting unit that adjusts the sensitivity of the image pickup unit, and
a changing unit which, when it has been determined by the determining unit that the shake correction is being implemented, changes the sensitivity of the image pickup unit such that the sensitivity is raised in comparison to when it has been determined by the determining unit that the shake correction is not being implemented.

3. The imaging apparatus of claim 1, further comprising
a shutter speed detecting unit that detects the shutter speed, and
a limiting unit that limits the shutter speed such that the shutter speed detected by the shutter speed detecting unit becomes equal to or greater than a predetermined speed when it has been determined by the determining unit that the shake correction is being implemented.

4. The imaging apparatus of claim 2, further comprising
a shutter speed detecting unit that detects the shutter speed, and
a limiting unit that limits the shutter speed such that the shutter speed detected by the shutter speed detecting unit becomes equal to or greater than a predetermined speed when it has been determined by the determining unit that the shake correction is being implemented.

5. The imaging apparatus of claim 3, further comprising a warning unit that issues a warning when a shutter speed less than the predetermined speed has been detected by the shutter speed detecting unit.

6. The imaging apparatus of claim 4, further comprising a warning unit that issues a warning when a shutter speed less than the predetermined speed has been detected by the shutter speed detecting unit.

7. An imaging apparatus including the function of conducting automatic exposure control and the function of conducting shake correction with respect to digital image data acquired by an image pickup unit, the imaging apparatus comprising:
a determining unit that determines whether or not the shake correction is being implemented;
a switching unit which, when it has been determined by the determining unit that the shake correction is being implemented, switches the shutter speed such that the shutter speed is raised in comparison to when it has been determined by the determining unit that the shake correction is not being implemented;
an adjusting unit that adjusts the sensitivity of the image pickup unit;
a changing unit which, when it has been determined by the determining unit that the shake correction is being implemented, changes the sensitivity of the image pickup unit such that the sensitivity is raised in comparison to when it has been determined by the determining unit that the shake correction is not being implemented;
a shutter speed detecting unit that detects the shutter speed;
a limiting unit that limits the shutter speed such that the shutter speed detected by the shutter speed detecting unit becomes equal to or greater than a predetermined speed when it has been determined by the determining unit that the shake correction is being implemented; and
a warning unit that issues a warning when a shutter speed less than the predetermined speed has been detected by the shutter speed detecting unit.

8. An imaging method including the function of conducting automatic exposure control and the function of conducting shake correction with respect to digital image data acquired by an image pickup unit, the imaging method comprising:
determining whether or not the shake correction is being implemented; and
when it has been determined that the shake correction is being implemented, switching the shutter speed such that the shutter speed is raised in comparison to when it has been determined that the shake correction is not being implemented.
